(19) United States
(12) Patent Application Publication
(10) Pub. No.: US 2018/0311021 A1
(43) Pub. Date: Nov. 1, 2018

(54) Dental cleaning instrument

(71) Applicant: Lan Allen, Tucson, AZ (US)

(72) Inventor: Lan Allen, Tucson, AZ (US)

(21) Appl. No.: 15/731,192

(22) Filed: May 1, 2017

(51) Int. Cl. A61C 17/02; A61C 1/00

(52) U.S. Cl. CPC A61C 17/0208; A61C 17/0217; A61C 1/0023; A61C 17/0202

(57) ABSTRACT

A tooth cleaning apparatus for an incapacitated patient which utilizes pressurized liquid to dislodge debris from a tooth area and a suction pump to remove the debris and spent liquid from the incapacitated patient. A handle portion has a first channel which delivers the pressurized liquid and a second channel for the suction function. These channels communicate with a head portion which is configured to be placed over a tooth of the incapacitated patient to simultaneously both rinse and suction the debris and liquid. In this manner, excess water and debris is prevented from collecting in the mouth of the incapacitated patient.

This is a continuation-in-part of U.S. patent application Ser. No. 14/756,912, entitled “Dental Cleaning Instrument” filed on Oct. 28, 2015, inventor Lan Allen.

### BACKGROUND OF THE INVENTION

This invention relates generally to dental instruments and more particularly to dental instruments used to clean teeth of debris.

While the vast majority of dental patients have full use of their swallowing and gag reflex, there are many patients who do not. These includes mentally disabled patients, comatose patients, patients with dementia, and brain damaged patients.

For these patients, oral care often entails the most rudimentary of procedures such as rinsing debris from the patient's mouth; but, all too often, the technique is handicapped by the patient's disability since the rinsing water collects and causes anxiety and distress. All too often even this most basic of oral care is neglected due to difficulty dealing with these incapacitated patients.

For these patients, the only option is to manually clean the teeth without the use of water or liquids.

It is clear there is a need to improve instruments used to clean the teeth of patients who are in various states of invalidity.

### SUMMARY OF THE INVENTION

The invention is a tooth cleaning apparatus for an incapacitated patient. Pressurized liquid is used to dislodge debris from a tooth or group of teeth and surrounding area while a suction pump simultaneously removes the debris and liquid from the incapacitated patient. The instrument uses a handle portion with two internal channels. A first channel delivers the pressurized liquid and a second channel performs the suction function.

These channels communicate with a head portion which is configured to be placed over at least one tooth of the incapacitated patient, thereby allowing the operator to address individual teeth. The head portion simultaneously rinses the area and suctions the debris and liquid. In this manner, excess water and debris is prevented from collecting the mouth of the incapacitated patient.

In the preferred embodiment, the head portion is placed over one tooth to assist in cleaning of a specific area.

The assembly uses a liquid pump which draws a liquid from a reservoir and delivers the liquid under pressure. In this context, the liquid is any of a variety of liquids used in the dental profession such as water, cleansers, and chemically enhanced water.

Delivering the liquid under pressure is well known to those of ordinary skill in the art and include, but is not limited to the techniques described in: U.S. Pat. No. 9,050,157, entitled “Dental Water Jet with Storage Container Reservoir Cover” issued Jun. 9, 2015, to Boyd et al.; U.S. Pat. No. 8,641,649, entitled “Pump for Dental Water Jet” issued Feb. 4, 2014, to Boyd et al.; and U.S. Pat. No. 9,062,473, entitled “Water Jet Pool Cleaner with Opposing Dual Propellers” issued Jun. 23, 2015, to Erlich; all of which are incorporated hereinto by reference.

In one embodiment of the invention, the liquid includes an abrasive element which assists in the removal the debris. One such technique is described in U.S. Pat. No. 9,073,175, entitled “Method for the Design of a Technology for the Abrasive Waterjet Cutting of Materials” issued Jul. 7, 2015, to Valicek et al. and incorporated hereinto by reference.

In conjunction with the pressurized liquid, a suction pump creates a removal mechanism for the dislodged debris and liquid within the patient's mouth. This is done by providing a less than atmospheric pressure environment. The removed material is deposited into a reservoir or is discharged into a sink for disposal.

Those of ordinary skill in the art readily recognize a variety of mechanism which can be used for the suction activity, including but not limited to the techniques described in: U.S. Pat. No. 9,044,294, entitled “Dental Suction Adapter” issued Jun. 2, 2015, to Herdocia; and, U.S. Pat. No. 9,044,293, entitled “Oral Cavity Suction Device” issued Jun. 2, 2015, to Reyes; both of which are incorporated hereinto by reference.

The removed liquid and debris is ideally caught in a reservoir which is ideally removable and disposable to maintain a sterile and hygienic environment. This also allows for the creation of a totally portable apparatus which does not require access to a sink for disposal purposes. Those of ordinary skill in the art recognize a variety of techniques which might be used in this context, including, but not limited to: U.S. Pat. No. 8,449,295, entitled “Oral Irrigation and/or Brushing Devices and/or Methods” issued May 28, 2013, to Hegemann; incorporated hereinto by reference.

The user controls the placement and movement of the assembly using a handle portion which is grasped by a user. Within the handle are two channels used to communicate the pressurized liquid and for the application of the suction/evacuation.

A variety of handles can be employed in this context, including, but not limited to that described in U.S. Pat. No. 9,055,960, entitled “Flexible Surgical Devices” issued Jun. 16, 2015, to Stoy et al.; incorporated hereinto by reference.

A head portion is secured to the handle and utilizes irrigation ports to direct the liquid against the tooth and surrounding area. Suction ports evacuate liquid and dislodged debris from around the tooth.

In some embodiments, the head portion also includes the ability to illuminate the treatment area to assist in the application of the head portion to the tooth. Those of ordinary skill in the art readily recognize a variety of such techniques for illumination, including but not limited to those described in U.S. Pat. No. 9,028,251, entitled “Illuminating Dental Instrument, Coupling and Method of Use” issued May 12, 2015, to Walsh et al. and incorporated hereinto by reference.

The handle/head is ideally connectable to the suction pump and the liquid pump using detachable couplings.

While some embodiments of the invention are disposable, some embodiments are constructed of materials capable of being sterilized using an autoclave. Autoclave sterilization involves the application of pressure with high heat (121 degress C.) for an extended period of time.

In the preferred embodiment, the source for the liquid is provided in a disposable prepackaged reservoir. The aspirated liquid/debris is collected in a disposable reservoir. In this manner, the assembly is kept in a sterile condition.

Activation of the mechanism is through either a manually operated valve or via a foot control. In one embodiment of the invention, pressure on the head portion (when it is pressed against the tooth) cause the suction to begin and the liquid to be expelled. In some embodiments, the suction is activated prior to the opening of the valve for the pressurized liquid to prevent excess liquid from being collected in the patient's mouth.

In other embodiments, within the valve, the orifice associated with the liquid is smaller than an orifice associated with the suction activity to accommodate the extra volume from the debris and to assure an excessive level of suction is provided compared to the amount of pressurized liquid being applied.

The invention together with various embodiments will be more fully explained by the accompanying drawings and the following descriptions thereof.

### DRAWINGS IN BRIEF

FIG. 1, graphically illustrates the preferred embodiment of the invention.

FIG. 2, illustrates the preferred embodiment for the head portion.

FIG. 3, illustrates an embodiment of the valve mechanism used in the invention.

FIGS. 4A and 4B, are top and side views of an embodiment of a head portion of the invention which addresses more than one tooth and which cleans both the outside and inside of the tooth.

### DRAWINGS IN DETAIL

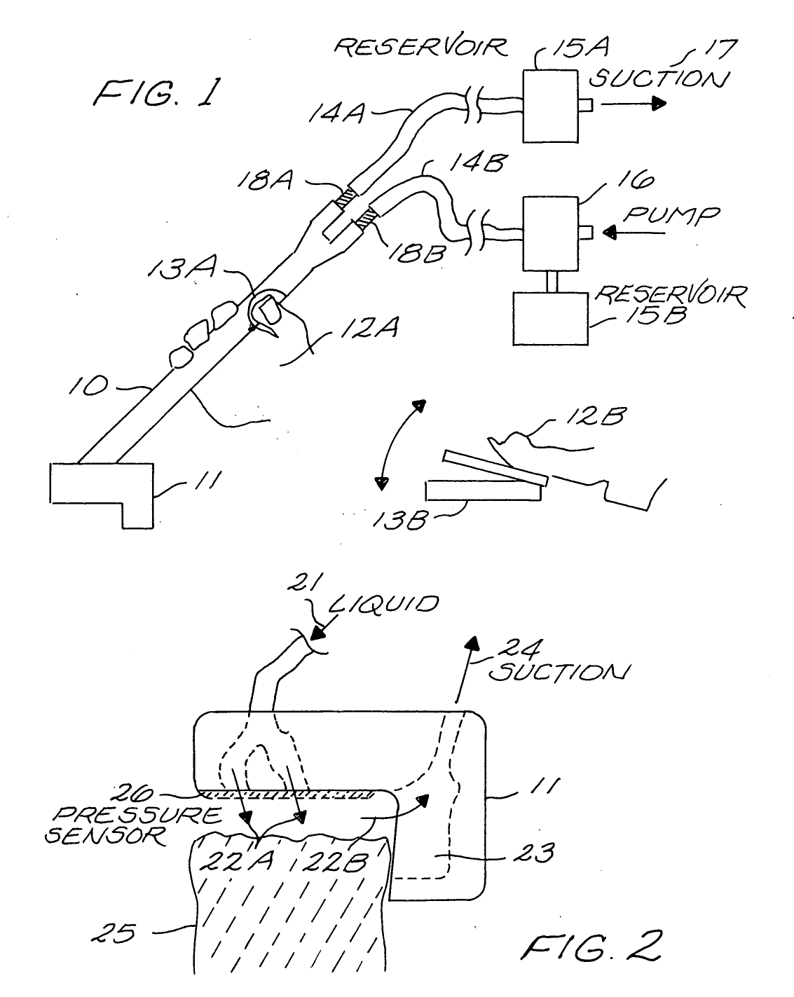

FIG. 1, graphically illustrates the preferred embodiment of the invention.

The assembly shown in FIG. 1, has a handle portion 10 which is adapted to be grasped by a user 12A. Within the handle are two channels (not shown) which are used to communicate, via hose 14B, the liquid (e.g. water or sterilizing agent) drawn from reservoir 15 and pressurized using pump 16. The second channel (not shown) is used to evacuate the debris and spent liquid via suction 17 (less than atmospheric pressure) allowing the withdrawn liquid/debris mixture to be collected in reservoir 15A.

In one embodiment, user's hand 12A is able to activate switch 13A on handle portion 10 to activate pump 16 and suction 17; in an alternative embodiment, user's foot 12B activates foot switch 13B to perform the activation process.

Head 11 is positioned on the end of handle portion 10 and is used to apply the liquid (from pump 16) and the suction (from suction 17) against the tooth and surrounding area being treated.

In the preferred embodiment, handle 10 is disengaged from tubing 14A and tubing 14B using disconnects 18A and 18B respectively. This allows the combination of handle 10/head 11 to be either disposed or, alternatively, to be sterilized using autoclave sterilization temperatures and pressures. If autoclave sterilization is desired, the handle 10/head 11 must be manufactured using a material which is capable of withstanding the autoclave procedure.

FIG. 2, illustrates the preferred embodiment for the head portion.

Head portion 11 is attached to an end of the handle portion (not shown) and configured to be placed over a tooth 25. The pressurized liquid 21 is directed against tooth 25 via ports 22A. Pressurized liquid 21 causes debris around tooth 25 to be dislodged. The spent liquid and dislodged debris is removed via port 22B by suction 24.

In this embodiment, catch basin 23 is used to enhance the collection of the spent liquid and dislodged debris, thereby allowing suction 24 to be more effective.

In an alternative embodiment of the invention, a pressure sensor 26 is secured to the bottom face of head 11. This sensor activates liquid 21 and suction 24 when the head 11 contacts tooth 26. In this embodiment, excess uncontrolled spray of the liquid is minimized.

FIG. 3, illustrates an embodiment of the valve mechanism used in the invention.

Valve 30 is used to connect the suction 31A and the pressurized liquid 31B with their respective channels in the handle portion (not shown) for communication with the head portion (not shown).

Suction 31A is communicated with valve 30 using tubing 33A which passes through chamber 36 and is communicated to tubing 33B.

In like manner, pressurized liquid 31B is communicated to valve 30 via tubing 34A, passing through chamber 36, to tubing 34B.

Note that tubing 33A (the suction) is larger than tubing 34A (the liquid) in this embodiment to assure that the debris/spent liquid is fully removed without a “back up” of the liquid within the patient's mouth.

Dual plunger 35 has a dual shut off 32A and 32B operate in a gang relationship to close off or open when plunger 35 is moved as indicated by the arrow. This permits a single valve 30 to control both the liquid delivery and the suction removal.

In the preferred embodiment, the suction component is opened via plunger 35 before the liquid component is to assure full and complete removal of the spent liquid and debris.

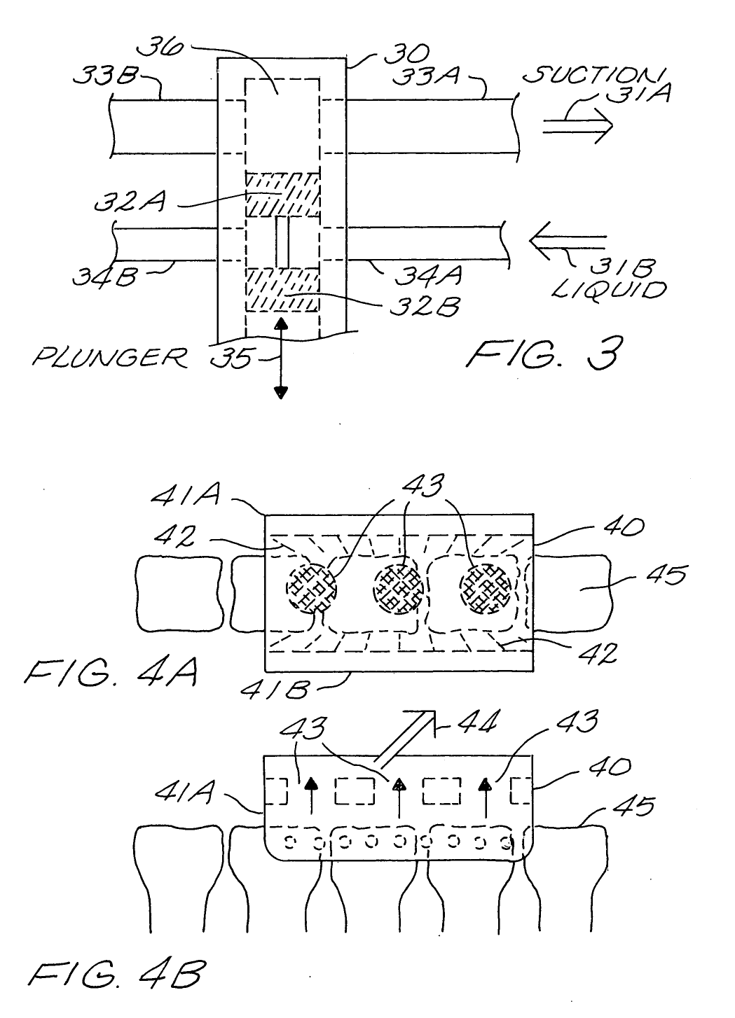

FIGS. 4A and 4B, are top and side views of an embodiment of a head portion of the invention which addresses more than one tooth and which cleans both the outside and inside of the tooth.

In this embodiment, head portion 40 is generally “U” shaped with aprons 41A and 41B adapted to address the interior and exterior of teeth 45. Note that in this embodiment, head portion 40 is able to address two or more teeth simultaneously, but the invention is not intended to be so limited and is ideally designed to address a single tooth for maximum manipulation by the operator.

Aprons 41A and 41B direct jets of water 42 against the teeth to dislodge debris which is then evacuated via suction openings 43 to be discharged 44.

The present embodiment is particularly useful as a single “swipe” of the instrument cleans both sides of the teeth. If a sterilizing agent is employed instead of water, this invention assists in reducing any contaminants which might affect an instrument during intubation of the patient; thereby reducing the secondary infections experienced during intubation.

It is clear the present invention provides for an improved instrument for cleaning the teeth of patients who are in various states of invalidity.

What is claimed is:

1. A dental instrument comprising:
a) a handle portion adapted to be grasped by a user, said handle portion having a first channel and a second channel therein;
b) a head portion attached to an end of the handle portion and configured to be placed over one tooth, said head portion having,
1) irrigation ports communicating with the first channel in the handle portion, said irrigation ports configured to direct a liquid flow against the tooth, and,
2) suction ports communicating with the second channel in the handle portion, said suction ports adapted to remove liquid and debris from the area of the tooth.

2. The dental instrument according to claim 1, wherein the handle portion and the head portion are capable of being subjected to autoclave sterilization temperatures and pressures.

3. The dental instrument according to claim 1, further including a manually operated valve controlling the liquid flow through said first channel.

4. The dental instrument according to claim 3, wherein pressure on the head portion causes said manually operated valve to open.

5. The dental instrument according to claim 3, wherein the manually operated valve is attached to the handle portion.

6. The dental instrument according to claim 3, wherein said manually operated valve also controls an amount of suction being applied to the second channel.

7. The dental instrument according to claim 1, further including:
a) a first connector for securing the first channel to a pressurized liquid source; and,
b) a second connector for securing the second channel to a suction source.

8. The dental instrument according to claim 1, further including a catch basin secured to the head portion and adapted to collect spent liquid, and wherein the suction ports are at least partially directed towards the catch basin.

9. An assembly for tooth cleaning comprising:
a) a liquid pump drawing liquid from a reservoir and delivering it under pressure;
b) a suction pump creating a less than atmospheric pressure environment;
c) a handle portion adapted to be grasped by a user, said handle portion having a first channel communicating with a pressurized side of the liquid pump and a second channel communicating with the less than atmospheric pressure environment of the suction pump; and,
d) a head portion attached to an end of the handle portion and configured to be placed over one tooth, said head portion having,
1) irrigation ports communicating with the first channel in the handle portion, said irrigation ports configured to direct a pressurized liquid flow against the tooth, and,
2) suction ports communicating with the second channel in the handle portion, said suction ports adapted to withdraw liquid and debris from the area of the tooth.

10. The assembly for tooth cleaning according to claim 9, further including:
a) a first disconnect adapted to selectively secure the liquid pump to the first channel; and,
b) a second disconnect adapted to selectively secure the suction pump to the second channel.

11. The assembly for tooth cleaning according to claim 10, further including:
a) a removable liquid reservoir configured to supply liquid to the liquid pump; and,
b) a removable debris reservoir configured to collect liquid and debris withdrawn from the tooth area by the suction pump.

12. The assembly for tooth cleaning according to claim 10, wherein the handle portion and the head portion are capable of being subjected to autoclave sterilization temperatures and pressures.

13. The assembly for tooth cleaning according to claim 10, further including a manually operated valve controlling the liquid flow through said first channel.

14. The assembly for tooth cleaning according to claim 13, wherein pressure on the head portion causes said manually operated valve to open.

15. An assembly for tooth cleaning comprising:
a) a liquid pump drawing liquid from a reservoir and delivering it under pressure;
b) a suction pump creating a less than atmospheric pressure environment;
c) a handle portion adapted to be grasped by a user; and,
d) a head portion attached to an end of the handle portion and configured to be placed over one tooth, said head portion having,
1) irrigation ports configured to direct a pressurized liquid flow from said liquid pump against the tooth, and,
2) suction ports adapted to withdraw liquid and debris from the area of the tooth in response to the suction pump.

16. The assembly for tooth cleaning according to claim 15, further including:
a) a removable liquid reservoir configured to supply liquid to the liquid pump; and,
b) a removable debris reservoir configured to collect liquid and debris withdrawn from the tooth area by the suction pump.
